(19) United States
(12) Patent Application Publication
(10) Pub. No.: US 2005/0124365 A1
(43) Pub. Date: Jun. 9, 2005

(54) Floor control in multimedia push-to-talk

(76) Inventors: Senaka Balasuriya, Arlington Heights, IL (US); Balakumar Jagadesan, Glendale Heights, IL (US)

Correspondence Address: MOTOROLA INC, 600 NORTH US HIGHWAY 45, ROOM AS437, LIBERTYVILLE, IL, 60048-5343, US

(21) Appl. No.: 10/729,659

(22) Filed: Dec. 5, 2003

(51) Int. Cl. H04B 7/00

(52) U.S. Cl. 455/518

(57) ABSTRACT

An apparatus, architecture and method for floor control in a Push-to-Talk system. A mobile station (203) may transmit a floor request message or messages and request multiple floors. Each floor may correspond to a media type having multiple media streams. A PoC server (201) assigns a priority to media types and/or media streams such that for example, a mobile station (203) may have a floor to transmit a video clip having audio and video streams to a talk group (207), and a member of the talk group may have a floor to transmit audio voice commentary on the media to the talk group (207). The embodiments of the present invention enable multimedia communication use cases without the need for duplication of the state machine at each node, thereby conserving resources.

### FIELD OF THE INVENTION

The present invention relates generally to cellular networks, and more particularly to Push-to-Talk (PTT) over a cellular network.

### BACKGROUND OF THE INVENTION

Wireless Push-To-Talk (PTT) networks are designed to facilitate communication among two or more users, and employ half-duplex communication. In such PTT systems, a server is typically a centralized control point that grants a “floor” to a PTT user who desires to speak to a respective talk group. Only one user may speak at one time. The user wishing to speak, pushes the talk button on a handset, gains the floor and speaks, while the other users may only listen during the interval.

There are possible use cases where a user may wish to transmit information, other than speech, for example a video file, to the talk group or to another user. However, the current systems of providing a floor to a user are not adequate for such use cases because the systems are limited to providing only one media stream in relation to a “floor”, in particular for voice data. Further, the restriction of one floor to one user at a time is also a limitation on use cases employing multiple media types.

One possible solution is to establish multiple PTT sessions for a single user, in which each session has a floor thereby simulating having multiple floors in a single PTT session. This approach however, would be extremely resource intensive because it would require duplication of the state machine, communication/interaction, memory, and CPU at every node in the PTT session including the MS, PTT server, and the network elements of the cellular packet networks.

Therefore, a need exists for an improved floor control mechanism for PTT systems such that multimedia use cases may be facilitated.

### BRIEF DESCRIPTION OF THE DRAWINGS

FIG. 1 is a block diagram of a wireless network employing Push-To-Talk (PTT) handsets and a Push-To-Talk over Cellular (PoC) server.

FIG. 2 is a block diagram of a mobile station and PoC server in accordance with an embodiment of the present invention.

FIG. 3 is a block diagram of a mobile station graphic display in accordance with an embodiment of the present invention.

FIG. 4 is a flow chart illustrating basic operation of a PoC server in accordance with the present invention.

FIG. 5 is a message flow diagram illustrating the basic messaging associated with a use case in accordance with an embodiment of the present invention.

FIG. 6 is a SIP/SDP message header in accordance with an embodiment of the present invention.

FIG. 7 is a block diagram illustrating the basic prioritization function of a PoC server in accordance with the present invention.

### DETAILED DESCRIPTION OF THE PREFERRED EMBODIMENTS

To address the above-mentioned need, a system and method for enabling PTT communications with multiple floors is provided herein.

In a first embodiment of the present invention, a single PTT session is established having multiple floors. Each media resource may have a floor in which a media resource comprises multiple media streams. Further, the PTT system of the present invention allows multiple users to simultaneously have a floor for the purpose of transmitting a particular media type. Each floor can be requested, released, and controlled separately with respect to a given user mobile station (MS). Additional floors, and media resources and streams associated with the floors, may be added and removed as participants join and leave the communication, respectively. Different floors using an identical media type are also assigned different priority levels by the PTT server. For example, voice audio may have a higher priority assignment than the audio from a media file.

A second feature of the embodiments of the present invention is that an MS may be pre-configured to receive certain media types but not others. The PTT server in this case, transmits media streams to a given MS based upon the MS configuration in addition to other criteria such as link capability for Quality of Service (QoS). The MS employs a set of soft keys for transmission of media types other than voice, and a PTT button for speech communication.

The term floor control as used herein references the processes by which a PTT server controls access to a MS by granting, denying, and releasing access to communication resources of the server, and controlling the communications and flow of data between various mobile stations during communications sessions. The embodiments of the present invention provide an improved floor control mechanism between a PTT server and an MS group. The embodiments of the present invention further enhance floor control mechanisms by providing a prioritization of media types for purposes of facilitating multi-media communications among two or more PTT users.

The term floor request message, in accordance with embodiments of the present invention may comprise transmission of a particular protocol message, for example a Session Initiation Protocol (SIP) message, between a mobile station and a server. The process by which the server determines resource availability for communication with other mobile stations is the process by which the mobile station floor request is granted or denied.

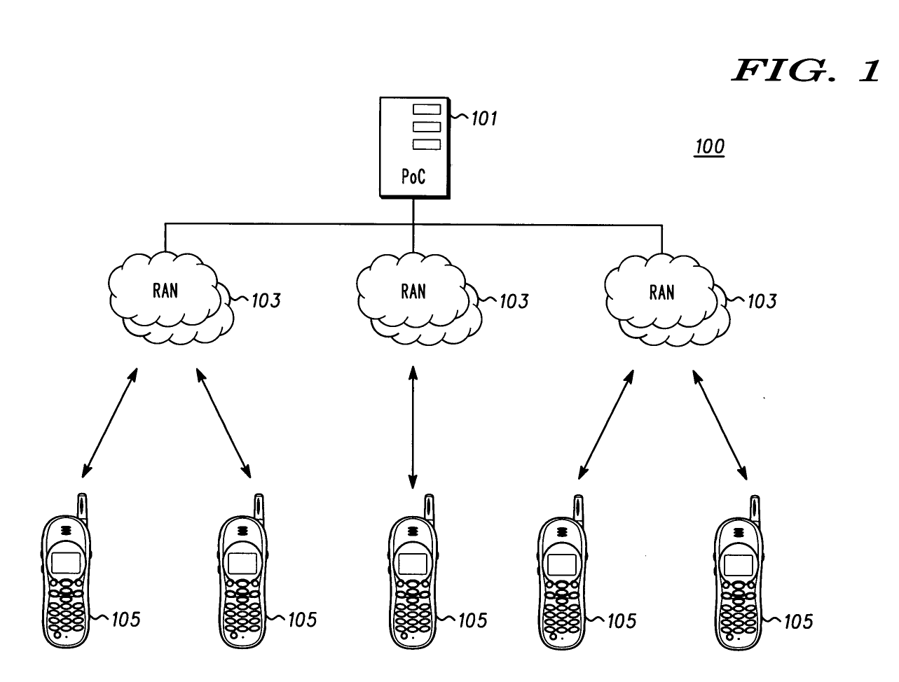

Turning now to the drawings, FIG. 1 illustrates a PTT network 100 having a plurality of Radio Access Networks (RANs) 103. Each RAN 103 may further comprise a plurality of base station transceivers (BTS) and base station controllers (BSC) providing radio communications resources for establishing communications with a plurality of mobile stations 105. The plurality of RANs 103 are connected to, and able to communicate with, a Push-to-talk over cellular (PoC) server 101. The PoC server 101 is a logical network element and may be integrated into other physical network elements of a RAN and still remain in accordance with the present invention.

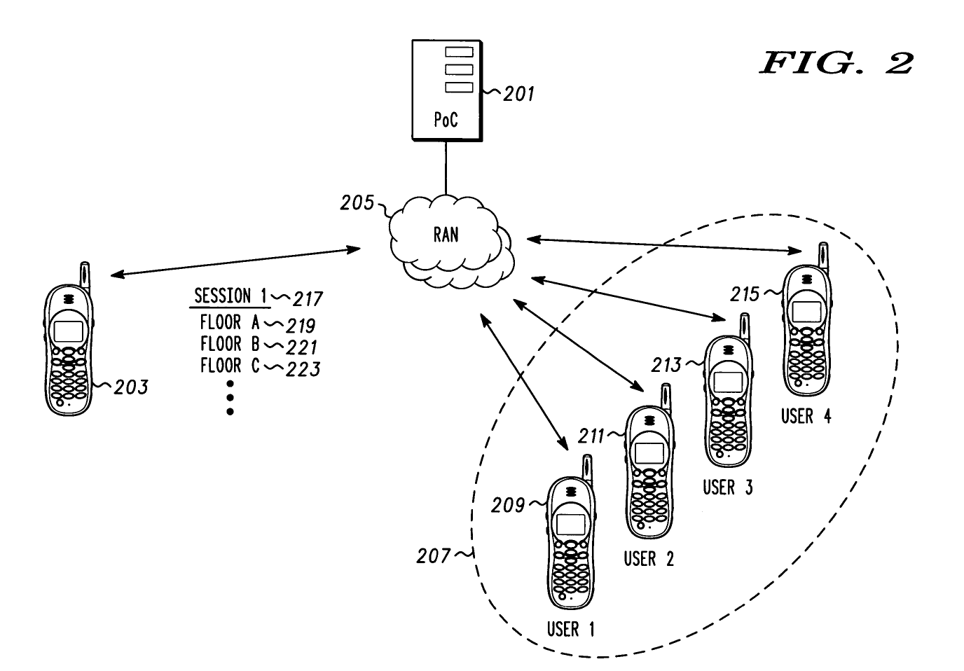

FIG. 2 illustrates an operation of a mobile station 203 in accordance with an embodiment of the present invention. In FIG. 2, mobile station 203 communicates with at least one member of a talk group 207, over a RAN 205 and using the PoC server 201 for PTT capability. For example, as shown in FIG. 2, the talk group 207 may include mobile stations 209, 211, 213 and 215 which are operated by users 1, 2, 3 and 4, respectively. Mobile station 203 may establish a single PTT communication session 217 in which the single session has multiple floors 219, 221, 223, etc. The PTT session 217 may be accomplished by, but is not limited to, a Packet Data Protocol (PDP) context on a GSM/GPRS, EGPRS, or UMTS network.

In an alternative embodiment, mobile station 203 may communicate with one or more of the talk group 207 mobile stations by establishing a connection directly via RAN 205 and without server 201. For example, mobiles station 203 may transmit a SIP INVITE message to of the talk group 207 mobile stations to establish a connection. In some embodiments of the present invention, a SIP message will contain priority indicators corresponding to various media resources, or media streams.

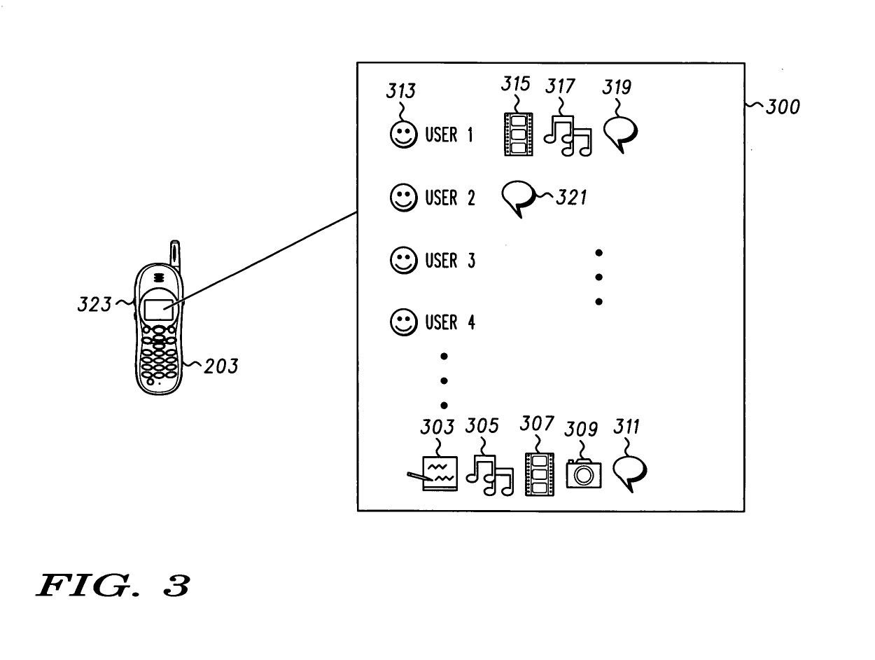

FIG. 3 provides further details of a graphic display 300, of mobile station 203, in accordance with an embodiment of the present invention. While FIG. 3 is exemplary only, and it is to be understood that there are other suitable ways to visually convey the information illustrated by FIG. 3 using a graphic display, the basic representations illustrated by FIG. 3 are helpful to understanding operation of the present invention.

The mobile station graphic display 300 comprises representations, which may be icons as illustrated, for requesting a floor for a given media type and corresponding to a media resource. Each media type may include one or more media. For example, whiteboard icon 303 would be selectable by the user to request the floor for a whiteboard application. Similarly, audio icon 305 enables the user to request the floor to transmit an audio stream or file, while video icon 307 enables the user to request the floor to transmit a video stream or file which may consist of both a video and audio data. Likewise, image icon 309 enables the user to request the floor to transmit an image file or stream of images, while commentary icon 311 enables the user to request the floor to transmit voice data.

Further, an icon may be used to represent a member of a given talk group. For example, user icon 313 indicates that User 1 is a member of the talk group in which the mobile station 201 user is a participant. Additionally, other icons may be used to indicate which floors, and also the corresponding media resources and media streams, that are currently held by the talk group participants. For example, video icon 315 and audio icon 317 may indicate that User 1 currently has the floor to transmit a video file with audio. Commentary icon 319 may indicate that User 1 also has the floor for voice transmission. If User 2 obtains the floor, for example to comment on User 1's video clip, the commentary icon 321 may indicate that User 2 has taken the floor for speech.

Each user of the talk group similarly has icons for indication of which user has the floor and for what media types. The activation of PTT button 323 of the mobile station 203 however, is still used to request the floor for speech, although an icon such as commentary icon 311 may be used additionally or as an alternative for initiating a floor request.

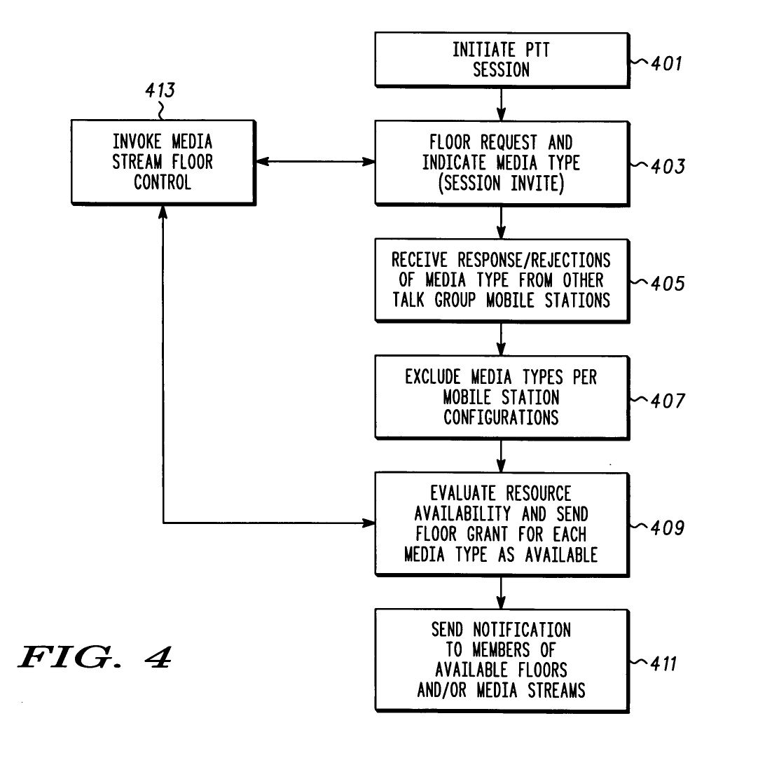

FIG. 4 is a flow chart illustrating basic operation of the PoC server 201 in accordance with the present invention. In block 401 mobile station 203 is engaged in a PTT session 217 over RAN 205 with PoC server 201. In 403, the user of mobile station 201 may request the floor for a given media type, by using an activation button or sensor of the mobile station. For example, the user may select one of the icons 303, 305, 307, 309, and 311 to request one of the floors 219, 221, 223, etc. of the PTT session 217. In 403, mobile station 203 transmits a floor request message to the PoC server 201. The floor request message may comprise a SIP message in some embodiments, and more particularly a SIP INVITE message. Block 413, which is shown bi-directionally connected to block 403, represents a determination by server 201 of whether resources are available for use by mobile station 203. Therefore, block 413 is invoked upon receipt of the floor request message by server 201 and will assign priorities to each media resource, media stream or file. Further in block 403, if the floor request can be granted then the server 201 will forward appropriate invite messages to the other mobile stations of the talk group.

Some mobile stations participating in the talk group, of which mobile station 203 is likewise a participant, may not have capabilities for certain media types, or may have preferences set to not receive certain media types. In block 405, messages from the mobile stations are received by the server 201 in response to the invite messages. These messages contain an indicator for whether the mobile stations are willing, or able, to receive the proposed media type. Alternatively, the media preferences and capabilities may be obtained from a second server, for example a Group and List Management Server (GLMS).

Block 407 represents the determination of which mobile stations will receive which media types, either via the response and/or rejection messages or the GLMS server as noted above. The server 201 will then transmit a floor grant message to mobile station 203 as shown in block 409. The resource availability determination is made by the media stream floor control block 413 prior to sending the floor grant. Likewise, a floor deny message may be appropriate in block 409 if the floor or resources are not available or if other criteria are not met. In block, 411 notification messages are sent by server 201 to the other mobile stations of the talk group 405. The graphic display 300 on each of the mobile stations of the talk group 207 is modified, based upon the block 411 notification messages, to display the appropriate icons for mobile station 203.

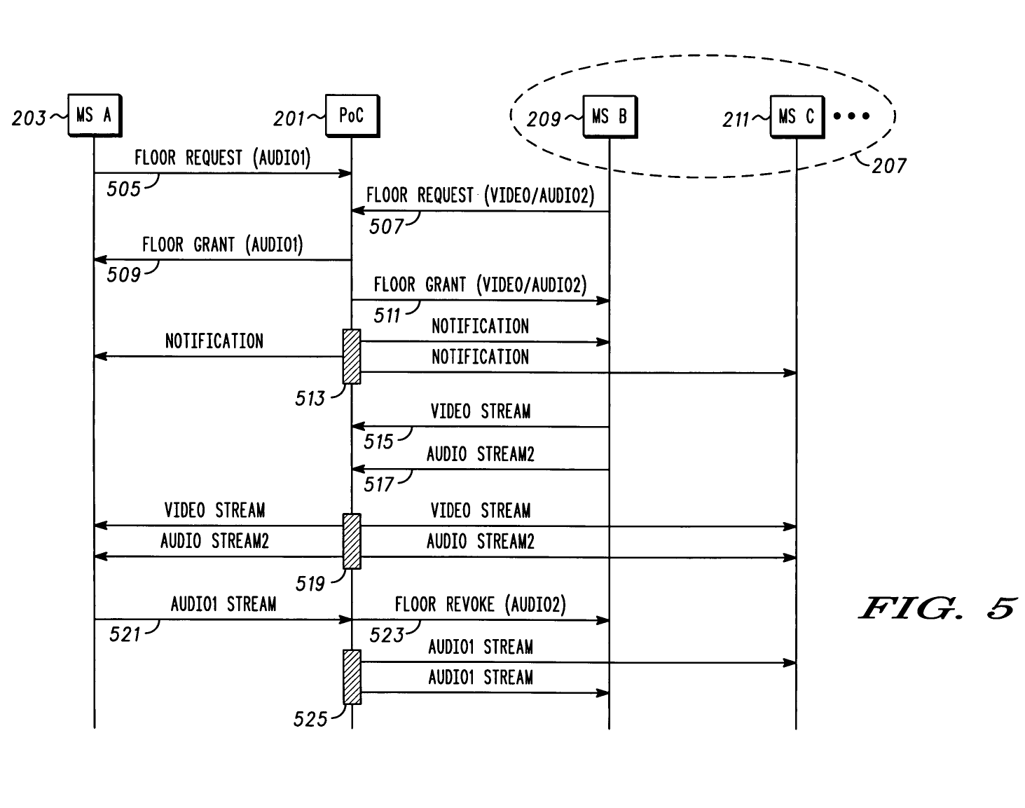

FIG. 5, provides further details of the messaging that occurs between the mobile station 203, the server 201, and other mobile stations of talk group 207. There are several floor control messages that are passed between a mobile station and the server 201 for example; Floor Request, Floor Grant, Floor Release, Floor Idle, Floor Taken, Floor Deny, and Floor Revoke. The transport protocols used in floor control messaging and server/mobile station bidirectional communications are Internet Protocols (IP) and utilize the User Datagram Protocol (UDP), and Real Time Protocol (RTP) for media. The floor control aspect of the server 201 is accomplished using RTP Control Protocol (RTCP), Session Initiation Protocol (SIP) and Session Description Protocol (SDP). For example, a portion of an RTCP header may by used for exchanging floor control information between a server and talk group mobile stations. More particularly the ASCII string of the RTCP header may be utilized for this purpose.

In accordance with an embodiment of the present invention, the ASCII string of an RTCP header, also known as the name string field, contains data that indicates the type of floor being requested, for example; audio, video, whiteboard, etc. Further in accordance with an embodiment of the present invention, the application-dependant data field of the RCTP header contains data that indicates other parameters associated with a floor, for example; floor number, floor status such as granted, taken, denied, queued, etc.

Other embodiments may use alternatives to RTCP and still remain in accordance with the present invention. For example, Simple Object Access Protocol (SOAP) may be utilized to contain the above described information in accordance with the present invention.

FIG. 5 illustrates a possible use case that may be realized using an embodiment of the present invention. It is to be understood that FIG. 5 does not show all of the messages that flow between the mobile stations and the server, but only shows the messages necessary for understanding the embodiments of the present invention.

Returning to FIG. 5, a mobile station may establish a session having a maximum number of simultaneous media streams for example, two audio streams and 1 video stream. In an alternative embodiment, the session may have a maximum number of floors rather than a maximum number of media streams. For example, one session may have two floors; a first floor enabling a movie clip with audio and video, and a second floor to allow other users to make voice commentary regarding the movie clip. Floor control would determine when one, several, or all media floors are granted, revoked, or released.

Returning again to FIG. 5, the purpose of the mobile station B (MS-B) 501 session, in accordance with the example use case, is to play a movie clip having a video stream and an audio stream. Whether the PoC server 201 grants the floor request, or requests, will depend on availability of the media streams and possibly additional criteria such as QoS priorities.

In any event, mobile station A 203 may request the floor for speech by transmitting a floor request message 505 to PoC server 201. Either, simultaneously or subsequently, mobile station B 209 may request the floor for the movie clip via message 507. In some embodiments of the present invention, message 507 may comprise two floor request messages, one for each media type. Assuming resources are available for the requests 505 and 507, the PoC server 201 will send Floor Grant Messages 509 and 511 to the respective mobile stations 203 and 209. The PoC server transmits notification messages 513 to all mobile stations of talk group 207 such that the mobile stations may update their respective graphical displays as was briefly described previously with respect to FIG. 3.

Mobile station 209 may then proceed to stream video 515 and audio 517 to PoC server 201, which transmits the media streams to the other mobile stations 519. If the user of MS-A 203 wishes to comment on the movie clip and pushes the PTT button of MS-A 203, the PoC server 201 will assign, or will have previously assigned, a higher priority to speech. Therefore, in accordance with the present invention the audio floor to MS-B 209 will be revoked via floor revoke message 523. The PoC server will then stream audio from MS-A audio stream 521 to the other mobile stations 525. Important to note is that the PoC server 201 will continue to stream video 515 to the talk group 207, even though mobile station 203 has taken the floor for audio. The user of mobile station 203 may then make comments regarding the movie clip in accordance with the example use case.

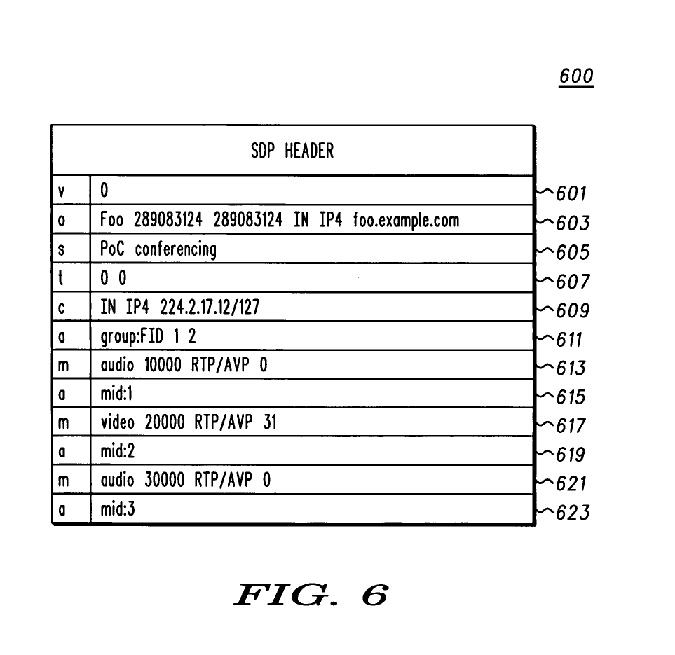

FIG. 6 illustrates one aspect of an embodiment of the present invention for a floor request message. FIG. 6 is an example of an SDP header used to request two audio streams and one video stream. The SDP session announcement 600, contains a media record for audio 613, 615; video 617, 619; and a second audio record 621, 623. Because a single IP address will be used as specified in record 609, each media stream will use a separate port. The media records 613, 617, and 621 specify the port via the syntax “<media> <port> [/<number of ports> (optional only)] <transport> <fmt list>,” such that ports 10000, 20000, 30000 are the example port numbers specified respectively, in example header 600.

Records 615, 619, 623 “mid” are used to identify a given media stream by for example a numeral as illustrated in the example 600.

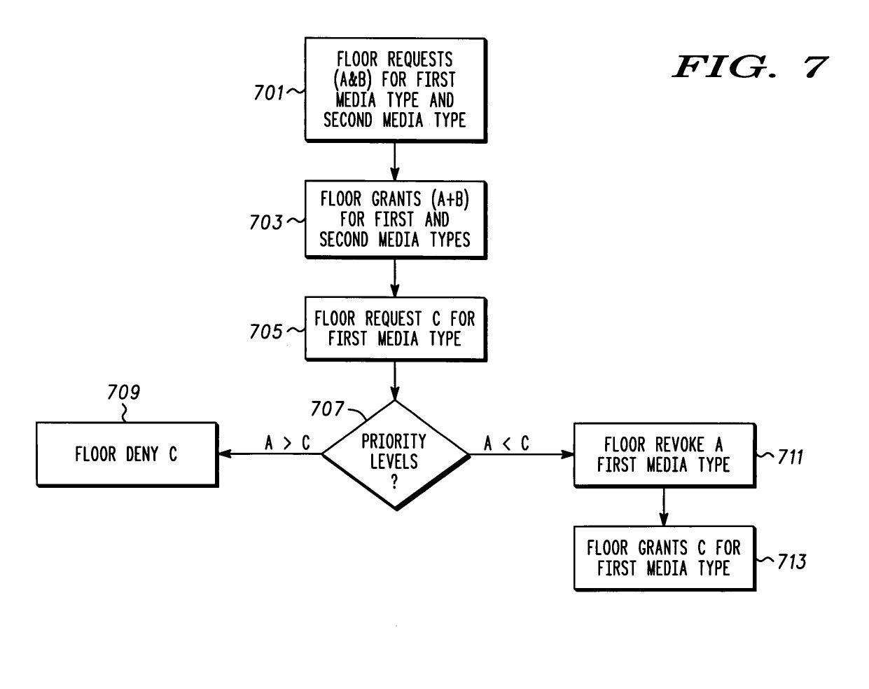

FIG. 7 is helpful to understanding the server 201 function with respect to prioritization of media resources and media streams which in some embodiments are requested using a message as exemplified by FIG. 6. In block 701, a floor request is transmitted from a mobile station to the PoC server for two different media types. If possible based on availability and other criteria, the server will grant the floor to the mobile station for both media types in block 703. In block 705, a second mobile station makes floor request “C” for an identical media type, which was already granted in block 703.

The server then compares the priorities in block 707 and will deny the request in block 709 if for example media “A” had a priority higher than media “C.” However, if media “A” has a priority lower than media “C” then the server will revoke the floor for media “A” in block 711 and grant the floor for media type “C” in block 713.

It is to be understood that the floor request handling illustrated by FIG. 7 may be among several mobile stations making an identical request, or for a single mobile station making multiple floor requests. In any event, various multi-media use cases, employing PET systems, may be imagined which may be implemented by using the various embodiments of the present invention.

While the preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims.

1. A mobile station of a dispatch communication system comprising:
a transceiver configured to communicate with at least one remote device for a session having a plurality of floors, each floor being associated with a media type.

2. The mobile station of claim 1, wherein each media type includes one of a white board media, an audio media, a video media, and an image media, a multimedia, and a commentary media.

3. The mobile station of claim 1, further comprising an activation sensor configured to indicate a particular floor of the session.

4. The mobile station of claim 1, further comprising a first activation sensor configured to indicate a first floor of the session and a second activation sensor configured to indicate a second floor of the session.

5. The mobile station of claim 1, further comprising an activation sensor having a first position associated with a first floor of the session and a second position associated with a second floor of the session.

6. The mobile station of claim 1, wherein said media type comprises a plurality of media streams.

7. The mobile station of claim 1, wherein said session comprises transmitting at least one invite message having a priority associated with at least one of said media type and a media stream.

8. The mobile station of claim 1, wherein said invite message is a Session Initiation Protocol message.

9. The mobile station of claim 1, wherein said invite message comprises Session Description Protocol records.

10. The mobile station of claim 1, wherein said session comprises a Packet Data Context of a GPRS cellular network.

11. A method for a communication device of a dispatch communication system comprising:
participating in a session having a plurality of floors, each floor being associated with a media type.

12. The method of claim 11, further comprising:
obtaining control of a particular floor of the session; and
providing a first content to the particular floor of the session in response to obtaining control of the particular floor.

13. The method of claim 11, further comprising:
releasing control of a particular floor of the session; and
receiving content from the particular floor of the session after releasing control of the particular floor.

14. The method of claim 11, further comprising:
obtaining control of a first floor of the session; and
providing a first content to the first floor of the session while receiving a second content from a second floor of the session.

15. The method of claim 11, further comprising:
releasing control of a first floor of the session; and
receiving a first content from the first floor of the session while providing a second content to a second floor of the session.

16. The method of claim 11, further comprising:
obtaining control of a first floor and a second floor of the session; and
providing a first content to the first floor and a second content to the second floor of the session concurrently in response to obtaining control of the particular floor.

17. The method of claim 11, further comprising:
releasing control of a first floor and a second floor of the session; and
receiving a first content from the first floor and a second content from the second floor of the session concurrently after releasing control of the first floor and the second floor.

18. The method of claim 17, wherein receiving content for the first floor and the second floor of the session concurrently comprises:
receiving the first content from the first floor controlled by a first device; and
receiving the second content from the second floor controlled by a second device.

19. The method of claim 11, wherein participating in a session having a plurality of floors includes participating in the session in which each media type includes one of a white board media, an audio media, a video media, and an image media, a multimedia, and a commentary media.

20. A server of a dispatch communication system comprising:
a transceiver configured to receive a floor request message associated with a media resource comprising at least one media stream, and further configured to assign a priority to at least one of said media resource and said at least one media stream.

21. The server of claim 20, wherein said floor request message comprises an invite message.

22. The server of claim 21, wherein said invite message is a Session Initiation Protocol message.

23. The server of claim 21, wherein said invite message comprises Session Description Protocol records.
